(19) United States
(12) Patent Application Publication
(10) Pub. No.: US 2014/0331136 A1
(43) Pub. Date: Nov. 6, 2014

(54) VIDEO DATA SHARING AND GEOGRAPHIC DATA SYNCHRONZATION AND SHARING

(71) Applicant: SARL EXCELLEANCE, DOUAI (FR)

(72) Inventor: Laurent Desmons, Waziers (FR)

(73) Assignee: SARL EXCELLEANCE, DOUAI (FR)

(21) Appl. No.: 14/270,194

(22) Filed: May 5, 2014

Related U.S. Application Data
(60) Provisional application No. 61/819,265, filed on May 3, 2013.

(51) Int. Cl. G06F 3/0484

(52) U.S. Cl. CPC G06F 3/0484
USPC 715/719

(57) ABSTRACT

Implementations described and claimed herein provide a system and methods for synchronizing video data and geographic data, and providing the synchronized data to other user's or device over a network.

### CROSS-REFERENCE TO RELATED APPLICATION

The present application is a non-provisional utility application claiming priority under 35 U.S.C. §119 to co-pending provisional application No. 61/819,265 titled “VIDEO DATA AND GEOGRAPHIC DATA SYNCHRONIZATION AND SHARING,” filed on May 3, 2013, which is hereby incorporated by reference herein for all purposes.

### TECHNICAL FIELD

Aspects of the present disclosure relate to video and geographic information coordination, and more particularly to systems and methods that facilitate the sharing of video information synchronized with geographic information.

### BACKGROUND

Video recording technology has become ubiquitously available, relatively inexpensive, and easy to use. For example, inexpensive high resolution digital cameras with full motion video, often in high definition formats are readily available. Similarly, smart phone technology commonly now comes with a high resolution digital video camera and sufficient memory to store several minutes or even hours of video. Video camera technology may also now be found in helmet mountable formats. With such readily available technologies, Internet based video sharing platforms, like YouTube™, have also now become wildly successful.

Similarly, systems for recording geographic location data, like geographic positioning system (GPS) data, have also become ubiquitously available, relatively inexpensive and easy to use. For example, GPS watches are readily available as are GPS tracking applications on smart phones and other dedicated mobile devices.

Despite these such amazing advances and proliferation of video technologies and geographic location technologies, there is a lack of technologies that bring these two platforms together. It is with these observations in mind, among others, that various aspects of the present disclosure were conceived and developed.

### SUMMARY

Aspects of the present disclosure involve a method of data synchronization within a browser operating on a computing device. Within the browser, the method involves receiving a video data file and a geographic data file. An image from the video data file is displayed as is a route corresponding to the geographic data file. A selection on the route is received, such as by a user touching or selecting with a mouse a point on a map, where the selection identifies a location corresponding to the image from the video data file. The received selection generates a synchronization association between the geographic data file and the video data file.

Aspects of the disclosure may further involve a system of data synchronization occurring at a server, which may be some form of computing device accessible over a network. The server provides access to an application in response to a request. The application is configured to run within a browser at a computing device from which the request was initiated and the application is further configured to receive a video data file and a geographic data file. The application may cause a display of an image from the video data file and a display of a route corresponding to the geographic data file. Finally, the application is configured to process a selection on the route identifying a location corresponding to the image from the video data file where the selection establishes a synchronization link between the geographic data file and the video data file.

Aspects of the disclosure may also involve a system of data synchronization, occurring at a server device that provides access to an application in response to a request. The application may be configured to run within a browser at a computing device from which the request was initiated. Further, the application may be configured to receive a video data file and to extract geographic data embedded within the video data file and to create a geographic data file from the extracted geographic data.

Finally, aspects of the present disclosure may further involve a method of synchronizing video and geographic data that comprises receiving a first wireless message indicating an initiation of recording a first data file at a first recording device, and at a second device, initiating a recording of a second data file at the second device in response to the receipt of the first wireless message.

### BRIEF DESCRIPTION OF THE DRAWINGS

FIG. 1 is an example network environment for uploading and sharing video files synchronized with geographic data files;

FIG. 2 is a flow diagram illustrating one example method of uploading and sharing video files synchronized with geographic data files;

FIG. 3A is a first example user interface displayed in a web browser where a user can upload and synchronize video and geographic data files;

FIG. 3B is a second example user interface displayed in a web browser as shown in FIG. 3A, here the video displaying an image corresponding to a location on the map identified by an arrow;

FIG. 4 is a flow diagram illustrating one example method of synchronizing a video file with a geographic data file where in some instances the video data includes geographic data;

FIG. 5 is a flow diagram illustrating one example method of automatically synchronizing a video file with a geographic data file by way of a synchronization signal transmitted from at least one of the video recording device or geographic data device to the other;

FIG. 6 is an example network environment for uploading and sharing video files synchronized with geographic data files, in this example the video device transmits a synchronization signal to the geographic device in order to synchronize the video file and the geographic data file;

FIGS. 7A-7E show example database tables for a member table, a track table, and a coordinates table; and

FIG. 8 is an example of a computing system that may implement various systems and methods discussed herein.

### DETAILED DESCRIPTION

Aspects of the present disclosure involve systems and methods for synchronizing video and geographic information and the sharing of synchronized video and geographic information, such as a video data file synchronized with a geographic data file, with third parties and or providing the synchronized data to an application or mechanism that may use the data. Aspects of the present disclosure may also involve synchronizing video data and geographic data when that data is recorded separately.

Some particular uses of the systems and methods discussed herein involve recording a video of an activity, such as bicycling, trail running, driving, motocross, cross country skiing, downhill (alpine) skiing, kayaking, and the like, and associating or otherwise synchronizing geographic data with the video file. Generally speaking, the geographic data and the video data are synchronized when there is a link or other relationship, such as a temporal relationship, between a specific portion of the video and the geographic data. The synchronized data may then be used by a variety of possible applications and made available to third parties, among other possible uses. For example, a user may obtain the synchronized data set, and play back the video along with a digital map so that a location on the map is displayed for the portion of the video being played. A digital display element on the map, such as a colorful dot or flashing dot, may move along the digital map in the same location as is being shown in synchronized video, and the video and digital display element may move contemporaneously. With such synchronized data it is possible to display a video along with geographic information related to the portion of video being shown, such as route along a digital map, elevation information, speed information, and other possible geographic or geographic data derived information. Example implementations and uses of the methods and systems discussed herein are primarily presented in the context of sporting activities; however, the systems and methods discussed herein are equally applicable to automobiles, automobile racing, boating, hang-gliding, parasailing, and nearly any activity that involves movement and where video and geographic data synchronization might prove interesting.

To further illustrate aspects of the technology described herein and expand on example uses, a system user may record a video of some or all of a particular bicycle ride. The types of rides that could be recorded are only limited by the user's creativity—the rider may ride and video a stage of a race, video themselves in a race with other riders, record their favorite mountain biking trail, etc. The user may also record or otherwise obtain geographic data associated with the ride. In one specific example, the user may use some form of geographic position system (GPS) device to record GPS geographic data during the ride while also recording video of the ride. Stated differently, the rider films video such as with a helmet camera, and at the same time has a GPS device recording GPS data during the ride.

After the ride, the user may access the system at a web browser and provide the video and GPS data to the system. In some cases the data may be pre-synchronized, as will be discussed in more detail below, and which case the user may use the system to locally edit, and otherwise define various possible meta-data attributes that will become associated with the data. The video and geographic data are separated to form two separate data files and those files are then uploaded to the system. Synchronization information may be included in either or both files, and may also be included in the meta-data file. In other instances, the video data and the geographic data may be recorded separately. The user accesses the system and identifies the two data sources associated with the same activity (e.g., the user selects the video data file and its corresponding geographic data file, or vice versa). Locally (on the user's device) but using functionality of the system served from a remote location, the user may synchronize the two data sets by associating a specific location in a portion of the video being displayed (e.g. a still or paused image showing a recognizable landmark in the video) with a specific location along a digital route displayed using the geographic data. The system generates synchronization information or creates a synchronization relationship associating the video frame or specific location with the specific map location, and because the video and the geographic information were recorded during the same time (regardless of whether one event started earlier, or ended later) the system then knows the geographic data elements associated with the video frames as the video progresses. The synchronized data is then uploaded to the system, which may be in two separate data files and a meta-data file, and the data may then be accessed and used by the creator (member), by other parties, or by devices.

Generally speaking, a video data file is synchronized with a geographic data file when there is a relationship created between the two files, data sets, or discrete data elements, or the files or data sets are integrated, such that the scenes in the video have a substantially accurate real world relationship to a geographic data element in the geographic data. A video file, whether compressed or otherwise processed, typically resolves to a frame that is momentarily displayed or projected, and through the proper speed of showing a sequence of frames, full motion is video is achieved. Various possible video devices may record at different speeds. Geographic data, such as GPS data, often involves a sequence of data elements that identify some particular location on the surface of the Earth. For example, GPS data may include a series of data elements describing latitude and longitude coordinates, and may also include elevation information. The accuracy and resolution of the geographic data is often related to the equipment used to record the data, the equipment and data used to determine or calculate elevation, the methods used to calculate location, the visibility and number of GPS satellites visible to the device, the resolution of the GPS device, and other factors. With the variability in the video and geographic systems, synchronization can nonetheless be achieved by linking at least one frame or discrete portion of the video to at least one geographic data element. For example, assuming both devices record during the same time over the same path, if the user links a frame of the video accurately with a geographic location, the other portions of the video and the geographic data will naturally align as they were recorded over the same period and along the same geographic path, even if data was not recorded at the same rate. Thus, synchronization information may involve some indicia that links or otherwise identifies a portion of the video with a geographic data element.

With such synchronization, a digital map display may identify a route along a map commensurate with the recorded video and may identify a specific point on the map, such as through an illuminated point or flashing icon that moves along the displayed route in accordance with the location of the particular part of the video being shown. A third party or a third party device may thus access the synchronized data and display or otherwise use the synchronized data. So, for example, a third party may preview a ride and get a sense for the difficulty of the ride by watching the video and also viewing the geographic information to understand the climbs, descents and flat sections of the ride. When elevation data is also included with the geographic data, an elevation profile may also be displayed and may also include some form of identifier related to the portion of the video being displayed. When speed data is included with or derived from the geographic data, a speed profile may also be displayed and may include some identifier related to the portion of the video being displayed. In such examples, an identifier is positioned on the elevation profile and/or the speed profile in the location corresponding to the video and map icon. A class instructor may use the video during an indoor cycling (IC) class or other exercise class, and instruct the class to alter the resistance of their IC bicycle, or alter their cadence, based on the geographic data. The data file or files with the synchronized information may also be used by exercise equipment in an automated way. Including real video and actual geographic information linked or otherwise synchronized with the video provides numerous possible creative uses for the data.

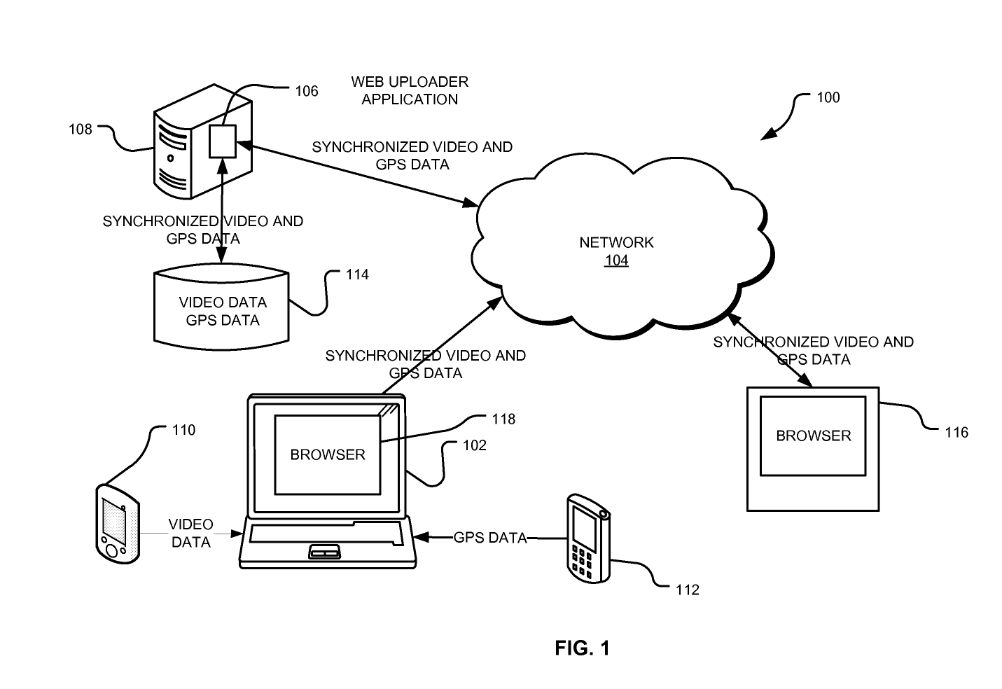

Referring to the drawings, FIG. 1 is a system diagram illustrating one possible computing environment 100 and the computing, video, and GPS devices that might be employed when realizing an implementation of the present disclosure. To begin, a user operating some form of computing device 102, such as personal computer, tablet or smart phone, with a connection to a network 104, accesses a web-uploader application 106 residing at a server 108 accessible via a network address, such as uniform resource locator or identifier (URL or URI). The web-uploader application is a computing mechanism by which the user may process video data from a video recording device 110 and also process geographic data from some form of device 112 capable of recording geographic data, in order to synchronize the data sets. The user device may be capable of directly capturing the video and/or geographic data and/or the data files may be loaded on the user device from another device capable of obtaining the data files. In the illustrated example, video data is loaded and stored at a personal computer 102 from a digital video recorder 110, and geographic data is loaded and stored at the personal computer 102 from the GPS device 112. The video data may be in a number of possible formats including mp3, mp4, avi, wmv, mov, and 3gp. The geographic data may also be in a number of possible formats including those conforming with NMEA 0183 or GPX.

After the video data and geographic data are made accessible to the web-uploader 106, the data may be synchronized so that the images in the video data are aligned with specific geographic data instances of the geographic data file. Stated differently and in one specific example, a particular frame or sequence of frames may be associated with a specific latitude and longitude of GPS data. After synchronizing (in cases where synchronizing is needed), the synchronized data sets are uploaded and stored in a database 114 from which it is accessible by another party operating a computing device 116, such as a personal computer, tablet or smart phone. In some specific implementations, the data files remain stored at the user device while synchronization and other operations occur, and then the data is uploaded. One or both of the video and geographic data files may include synchronization information, stored separately or as a single record. Further, a separate synchronization record, table or other computing structure, may be created and stored in the database or elsewhere, which may or may not involve distinct synchronization information being included in either of the data files. In one specific implementation, after the user synchronizes the data sets, three files are uploaded to the server—a video file, a GPS file, and a meta-data file.

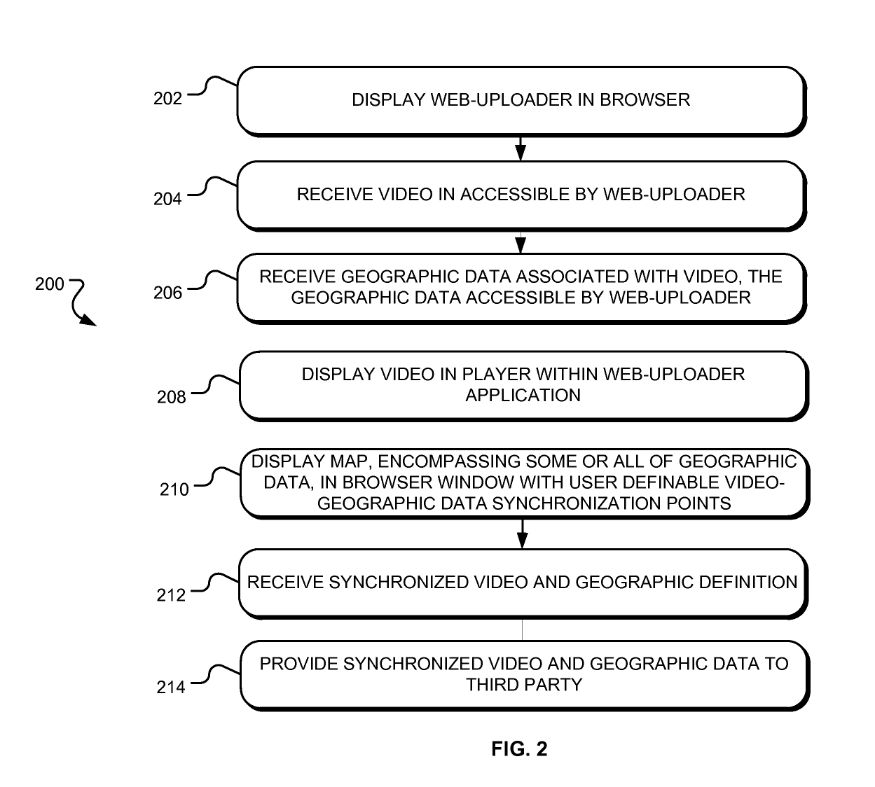

More specifically, and also now referring to the process described with respect to FIG. 2, the user's computing device 102 may run a browser 118 capable of accessing a computing device connected to the network 104, such as a website served from the web server 108, running the web-uploader 106 application that uses, at least in part, hypertext markup language (HTML) 5 or something similar. The web-uploader application presents, within the browser window, the web-uploader application (operation 202). One benefit of HTML 5 is that the operations may be performed within the application running on the web server 108 rather than requiring an application downloaded on the user device. Moreover, the web-uploader may interact with data files at or through the user device. It is nonetheless possible, to involve other versions of HTML and to further involve some form of functionality being present on the user devices in order to synchronize and otherwise process the video and/or geographic data files, and upload video and geographic data or to download previously loaded data. Furthermore, while the systems and methods discussed herein involve accessing a website by way of a browser, the methods discussed herein do not require a website or browser. Instead, a standalone application may be resident on the user device, and it may be configured to transmit information or otherwise provide data to a remote database or remote storage device or element of some kind accessible by a third party device of some kind. Alternatively, a user may process the data and load it to the server 108 using a file transfer protocol (FTP) or something similar.

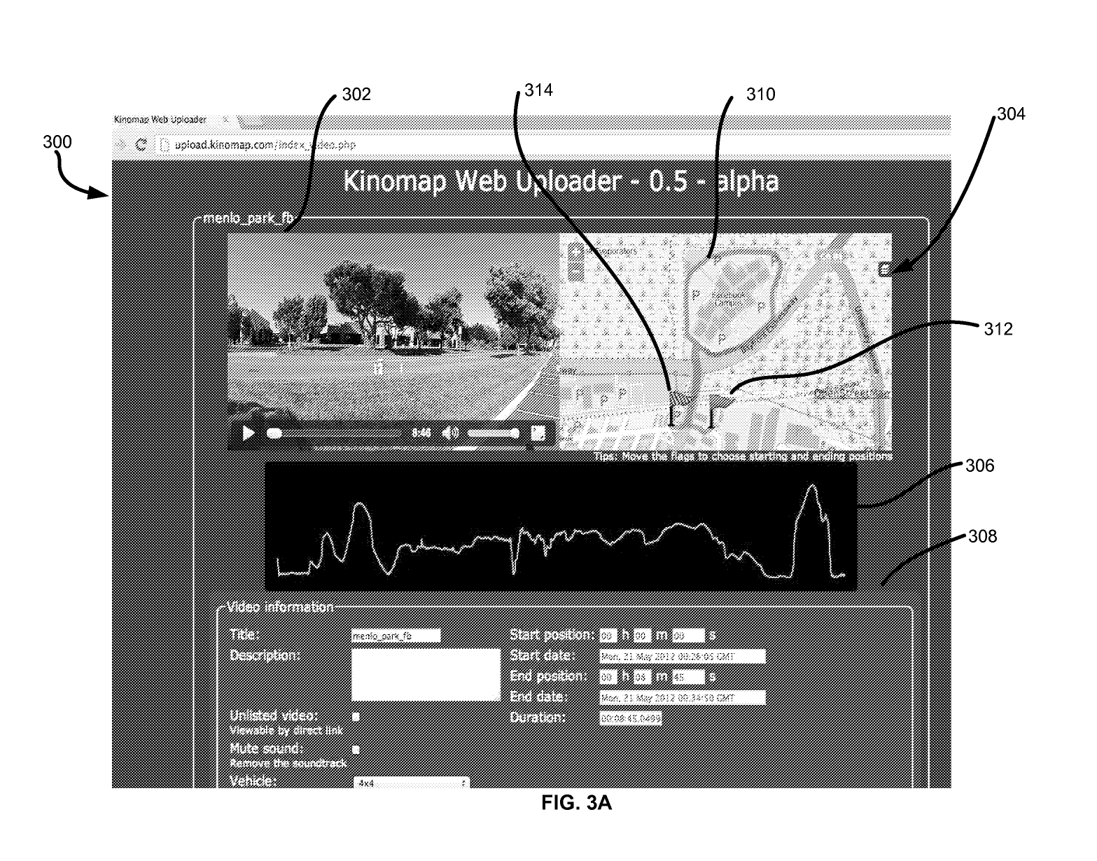

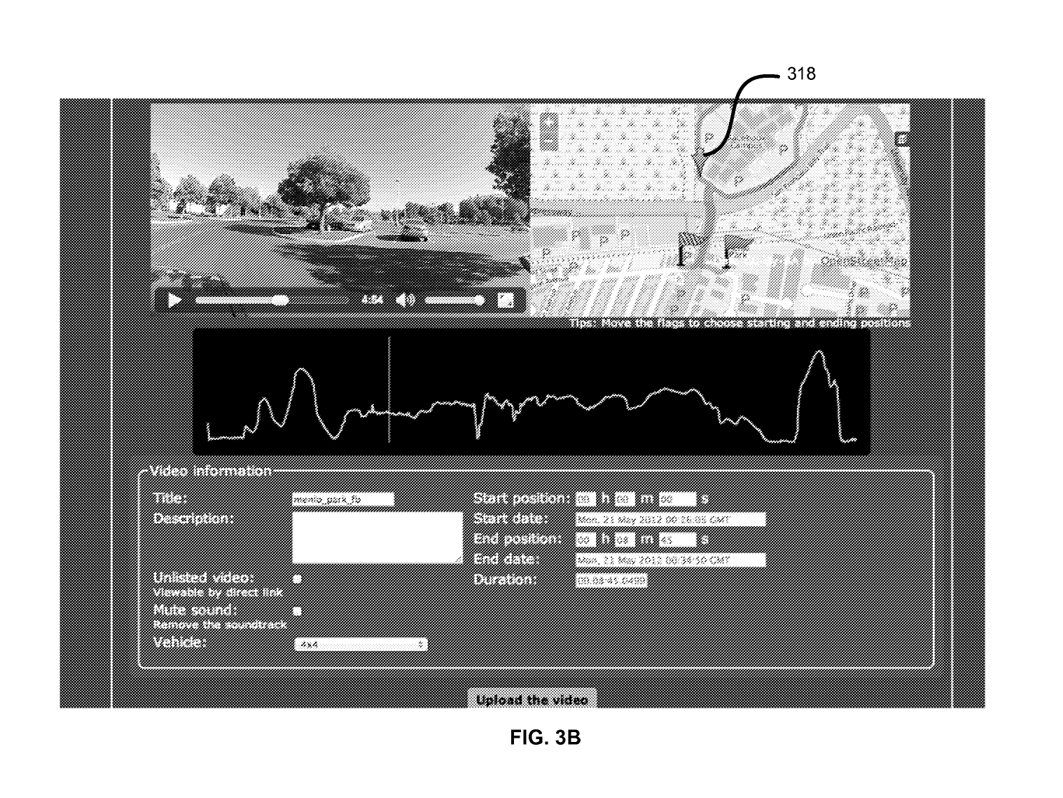

Referring to FIG. 3A, the web-uploader application 300 presents, within the browser, a video window 302, a map window 304, a speed window 306, and an input window 308. Initially, before a video file or geographic data file is identified to the web-uploader or otherwise accessed at the web-uploader application, the windows are blank. The windows in FIG. 3A are shown populated with information and that information will be discussed in more detail below.

Referring again to FIG. 2, at the computing device 102, the user loads a video file to the web-uploader application 106 displayed in the browser 118 (operation 204). Similarly, the user loads a geographic data file to the web-uploader application (operation 206). Here, in one specific example implementation, neither the video file nor the geographic data file are transferred to the web-loader application running on the server 108 or the database 114. Rather, the web-uploader is provided access to the files stored or otherwise accessible at the device 102. Alternatively, the video file and/or the geographic data file might be transferred to the web-uploader application for processing at the server by way of control from the user device. To provide the web-uploader access to the proper files, in one example, the user selects a video file or a geographic data file, such as by selecting the appropriate file icon on the user's desktop (if the file is stored on the desktop) and drags and drops the video file in the video window. This provides the web-uploader application, operating remotely but accessible at the browser, with the ability to further process the video file and/or the geographic data file as discussed herein. The user may also provide the web-uploader access to the files using other mechanisms such as through a file tree structure, drop down menu, or a video picker. For example, the web-loader may present a file tree structure where the user, through interaction with the file system residing on the device 102, navigate the files to identify a particular file and by selecting that file (e.g., through using a mouse and clicking on a selected file) provide the web-uploader with access to the selected file. Depending the operating system, the video device, or other factors, the user might also access memory at the connected device 110 and/or 112 and select the video residing with the remote device memory or the geographic data file at the remote device memory. In one specific instance, the data files are transferred to the user device 102 and remain stored at the user device while synchronization and other operations occur, and then the data is uploaded and stored at the remote database 114.

Regardless, when the video file is loaded or otherwise the web-uploader is provided with access to the video file, the web-uploader will display a video player in the video window, and will also display, within the video player, a still image of the first frame or some other frame, of the video file (FIG. 2, operation 208) as illustrated in FIG. 3A. Here, the video player is served from the server with the browser but the video file is accessed from the device 102. The video player application might also be present on the device 102. If desired, the user may then play the video from within the video window 302 of the web-uploader application 102. Similarly, when the geographic data file is loaded or otherwise the web-uploader is provided with access to the geographic data file, the web-uploader will display a digital map in the map window 304 (as shown), and will also display a route 310 on the map associated with the geographic data points of the geographic data file from start to finish of the route.

The video file may be recorded using any form of digital video recording device. Additionally, the video file may also be in various possible formats and conforming to various possible file formats, compression and encoding standards, and the like. In one specific implementation, the video file is provided in a form accepted by the web browser natively in HTML 5. In such a specific implementation, the video file may be a .mp4 file or a .mov file (or files) using H.264 (MPEG-4 AVC) video compression encoding.

The video may be recorded by a standalone video recorder. Alternatively, the video may be recorded using a smart phone with a high definition video camera, such as an iPhone™ that may also automatically apply H.264 and provide the video as a .mov file. Of course, like other specific technological platforms discussed herein, the use of an iPhone™ and the particular compression standards are not meant to imply that the technology discussed herein is limited to those platforms but rather is discussed simply to provide some specific illustrations. Additionally, the video recorder may only record video data or it may also be capable of recording geographic data associated with the video recording. In one example, the video recorder may be capable of recording GPS data with the video. One such device with video and GPS functionality is the CountourGPS™. In the event the recorded video is on conventional film, then the video should first be digitized into an acceptable format before providing the video file to the system.

Referring again to FIG. 2, the web-uploader also receives geographic data associated with the video file (operation 206). The geographic data may be provided to the web-uploader in a number of ways. It is possible for the user to load the geographic data asynchronously with the video data. Stated differently, there is no requirement that the user load video data and geographic data at the same time or during the same access of the web-uploader event. Thus, in the example of a bicycle ride, it is possible for a user to record a video of the ride and upload it to the system, and at a later time upload GPS data associated with the same ride. In such a case, as will be understood from the discussions that follow, the user would access the web-uploader application and select the preexisting video rather than loading a new video to the system.

In these examples, the video data and the geographic data are recorded during the same event. So, for example, a bicycle rider would record a video during a ride while at the same time recording GPS data. In such a situation, the video data includes inherent synchronization components with the geographic data because the two files are being recorded at the same time and along the same route. Thus, there may be a series of discrete video frames recorded over a period of time that correspond with a series of discrete geographic data elements recorded over the same period of time and along the same route as the video. Actually synchronizing the data files, as discussed herein, therefore may involve defining or otherwise including at least one synchronizing point or link between the files, which may be identified in either or both files or in a separate data structure or file, so that a specific video feature is aligned with a specific geographic data feature, such as by creating a link between a specific video frame and a particular GPS coordinate, and knowing the time or some other temporal aspect of the files which can then be used to align the series of video frames and the series of geographic data elements. However, also as discussed herein, should the device be capable of recording both video and geographic data, it is possible to obtain one file with both video data and geographic data that are synchronized by the device while recording. For example, the device may embed GPS data within the video file as they are being recorded. In another example, the two files may be started and stopped at the same time under some form of control, and by knowing the relationship between the two files, they are synchronized temporally.

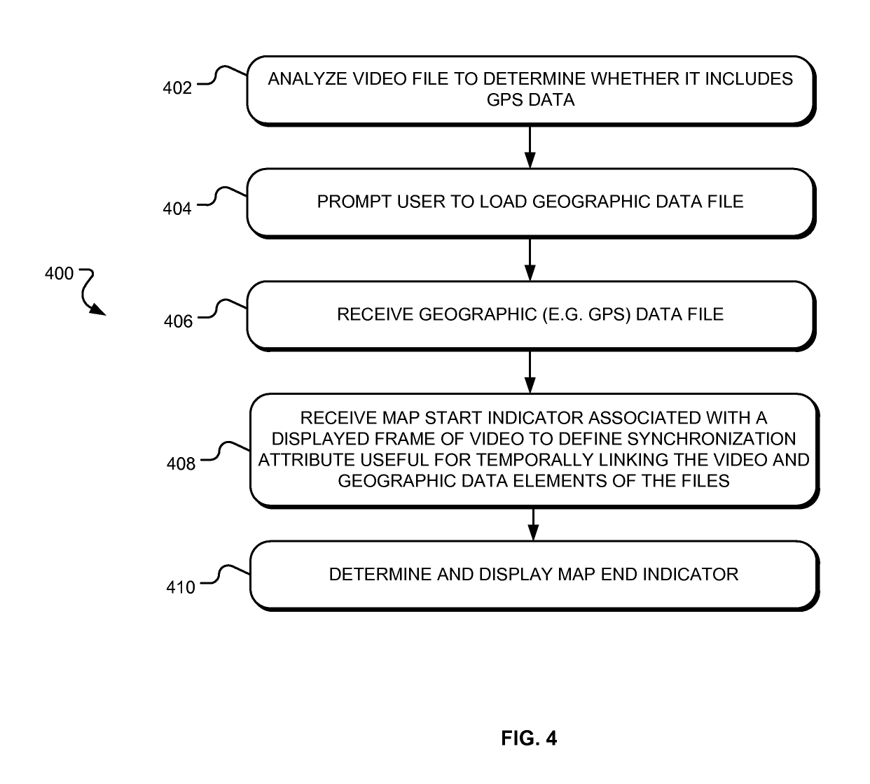

Referring now to FIG. 4, in the event the user is not working with a previously loaded video file, at the time a user drags and drops a video file in the video window (or otherwise provides the web-uploader with access to a video file), the web-uploader application may determine whether the uploaded video file includes integrated geographic data (operation 402). In one specific example, the web-uploader application analyzes a subtitle field of the video file to determine whether it contains geographic data (e.g., GPS data). If so, the web-uploader extracts the geographic data and stores a separate geographic data file on the device 102. The GPS data includes synchronizing frame information as the video from which it was extracted. In one particular example, one or more GPS data set elements, which would include a latitude and a longitude coordinate, is associated with a frame or set of frames to which the GPS data element corresponds. Since video frames may be recorded at a 30 or more frames per second, and GPS data may be recorded at a slower rate, such as one data element per second or per two seconds, there may be several frames associated with a single GPS data element (e.g., 30 frames associated with one GPS data element). Also, the geographic data file may be created and stored in the database 114 or some other memory location. It is also possible for the video device to separately record and save a geographic data file rather than embedding the geographic data within a field of the video file.

Alternatively and when the video data does not include geographic data, the web-uploader application prompts the user to load a geographic data file (operation 404). Referring again to FIG. 3, the user may drag and drop a geographic data file into an unpopulated map window 304. Alternatively, the user may also load the information to the web-uploader in other ways, some of which are expressly mentioned above. Regardless, when the geographic data is provided to the web-uploader, a map encompassing some or all of the GPS data is presented in the map window (FIG. 2, operation 208). The map also includes a highlight 310 of the map associated with the specific GPS data points from the uploaded GPS data file along with a first flag 312 (or other identifier) at the first map coordinate of the file and a second flag 314 (or other identifier) at the last map ordinate of the file where the map may include synchronization elements (FIG. 2, operation 208).

In one specific example, the geographic data device is a GPS device which may be referred to as a GPS receiver that records GPS data in either GPX format or NMEA 0183 form and which may be a dedicated device or one that includes GPS functionality such as a smart phone or the like, and the geographic data obtained and stored by the device in a geographic data file includes a series of data fields where each field may include a latitude coordinate, a longitude coordinate, elevation information, a calculated speed number, and possibly other information measured, derived, or calculated. Each data field may be recorded at the rate at which the GPS receiver calculates the information for the data field, which may be every one (1) second, every two (2) seconds, or at some other frequency depending on the device. The GPS device records the information in a geographic data file, which may be in comma separated form or some other format.

In FIG. 2 and in FIG. 4, it is shown or implied that the video file is first loaded in the video window followed by the geographic data being loaded in the geographic window. The system, however, requires no order of operations. Thus, it is possible for a user to first load a geographic data file and then load a video file. Order is involved when the geographic data is extracted from the video file, as the system must have the video file in order to extract the geographic data and create a file or simply extract a file. However, it is also possible, such as in the case of a smart device, such as an iPhone that includes both video recording technology and GPS technology, to have video data stored within a geographic data file, or as discussed above, for the device to create and store both a video file and a geographic data file during the same event, and with one or both files including synchronization information to link to the other file.

As discussed in more detail herein, the geographic data file may also include video synchronization information. In one example, the synchronization information may be an index to a position of the video, such as an index to a frame of the video, to which a particular data field of the geographic data file pertains. In a specific example, the first data field of the geographic data field may be indexed to a particular frame of a synchronized video file, which may be the first frame of the video file. As discussed herein, however, there is no requirement that synchronization information be limited to the first geographic data field and/or the first video frame. Similarly, synchronization information may be stored in the video file and refer to a particular data field of the geographic data field. Moreover, synchronization information may be stored in a separate file or database structure or in the nature of the data storage itself that includes synchronization information, as well as possibly other information, related to a video file that is synchronized with a geographic data file.

In the example of the FIG. 3A, the video data was taken from a car (4×4) (as entered by the user in the vehicle field of the window 308) that drove in a loop around a building campus as shown in the map displayed within the video window 302. The first frame of video recorded during the drive is shown in the video window. The user also simultaneously recorded a GPS file. It should be noted that in many instances, particularly when using a device without integrated GPS and video recording functions, the GPS file may include information not directly related to the video file and vice versa. For example, the user may start the GPS device before the start of the video recording and may stop the GPS device after the video is stopped. Such might be the case when a bicycle rider records a GPS file for an entire ride but only films a smaller segment of the overall ride. Similarly, even when the user is attempting to start and stop the GPS data recorder and video file at about the same time, it may be difficult or impossible to achieve simultaneous starting and stopping of the devices, particularly when the functions are provided by separate devices.

Nonetheless, returning to FIG. 3A, the web-uploader first assesses the range of latitude and longitude coordinates of the GPS file and displays a map 316 encompassing at least those coordinates. As shown in FIG. 3A, the displayed map includes the route 310 driven by the user as well as some surround area. In one example, Openstreetmap™ map data, which is in an open source map data source, is used to generate the map. Alternatively, proprietary map data sources such as Google Maps™, MapQuest, and the like may be used. Additionally, the actual route 310 associated with the specific latitude and longitude coordinates in the geographic data file is highlighted. In the example, the routes to and from the campus along with the route around the campus are highlighted.

As shown in FIG. 3B, when the video and map data are displayed, the user may fast forward, rewind, or otherwise alter the video frame being displayed, and an icon 318 on the map 316 will move along the route to the location corresponding to the image in the video window 302. In the example illustrated in FIG. 3B, the user has forwarded the video to a frame, shown in the video window 302 at 4 minutes and 54 seconds into the video, which video has a total elapsed time of 8 minutes and 45 seconds. As shown, the map illustrated in the map window 304 shows an arrow along the highlighted route. The arrow corresponds to the data element (latitude and longitude) recorded about 4 minutes and 54 seconds from the start of the video illustrated by the solid flag (the last data element at 8:45 is identified at the checkered flag on the map). As can be seen, there is also a line shown at the location of the speed graph shown in the speed window, with the line associated with the speed data for the geographic data element identified by the arrow. The speed graph is a graph of the calculated speed data points that may be included with each data element of the geographic data file. The system may also provide a contour or elevation map or graph from elevation data that may be associated with each geographic data element, and that map or contour would be shown in a separate window. It is also possible to provide other map views, such as perspective type map display rendering that also includes elevation contours. Within such a perspective view, the viewer would both be able to see the position on the map as well as get a visual sense for the elevation or grade of the route being traveled.

Regardless of whether the geographic data is embedded in the video file or loaded separately, the web-uploader allows the user to synchronize the start of the geographic data with the beginning of the video file and to also identify the end of the geographic data. In the example shown in FIG. 3A, the first frame of the video file is illustrated in the video window 302. Referring again to FIG. 4, to synchronize the geographic data to the video data the user may identify a location on the map shown in the displayed video frame (operation 408). In one specific example, to synchronize the geographic data with the video data, the user drags the start indicator flag 312 to the map location associated with the displayed video. For example, if the displayed video frame illustrates a recognizable street corner, the user would drag the start indicator flag to the same street corner location on the map 316. The user may zoom the map in order to accurately place the start indicator flag. Should the frame of displayed video not be recognizable to the user, the user may use the video viewer to forward the video to a recognizable location, and then drop the map indicator flag 312 on the map location associated with the recognizable location. Within the GPS data, the video frame associated with the selected map location may be stored with the GPS data. Similarly, it is also possible to store the GPS coordinate with the video frame information. Finally, a meta file may also be created that includes synchronization or linking information between the GPS data and the video data. While multiple synchronization points for each data file type may be identified, it is possible to only identify one synchronization point. The system identifies the end of the track (route) once the beginning of the route is flagged, and will automatically display an end flag at the end of the route (operation 410).

The video file is associated with a time parameter (or parameters) between the start of the video and the end of the video. Similarly, the GPS data is also associated with a time parameter. Both the video file time parameter and the GPS data may be normalized to real time or some other common time parameter. Regardless, because the rider is moving and recording video and geographic data, the geographic data may be automatically synchronized with the video data once a video frame or set of frames is synchronized to a geographic location. Hence, it is sufficient to define or otherwise include one synchronization location. When the first video frame is synchronized with the geographic data (as shown in FIG. 3A), the system may also automatically remove any geographic data preceding the location of the synchronization. Thus, for example, if a user records GPS data prior to the location where the video recording started, that prior GPS data will not be uploaded when the process is completed.

Alternatively, all of the recorded GPS data is transferred to the database with information to synchronize the GPS data to the video data. In such a situation, a third party or device may only receive the GPS data associated with a video file but the entire GPS data would be stored. Accordingly, if the user that originally transferred the video and geographic data to the database made an error in synchronization or desired to further edit the video and resynchronize the geographic data, that raw original data would still be available even if the user had deleted the original file on the user device 102 or connected device 110. In such an instance, the user would access the web-uploader but would select a file from the remote database rather than from local storage.

If some frame besides the start frame is associated with the start indicator, the web-uploader may automatically synchronize the start of the video data and the start of the GPS data. In such a case, the user initially sets the flag at a point in the map and then once the start of the route is identified, the flag will be displayed at the start of the route. The system is able to automatically determine and set the start synchronization regardless of whether the start of the GPS data precedes the start of the video file or whether the start of the GPS data follows the start of the video file. Generally, the system is able to determine the starting map location by knowing the elapsed time from the first map location and the selected map location, and comparing it to the time of the video frame shown in the window 302. To illustrate the operation, assume, for example, that the selected start latitude and longitude location for the synchronization occurs at time equal to 5 minutes, meaning that the elapsed time between the first GPS data input and the selected GPS point is 5 minutes. In one example scenario, the video frame being synchronized is at a greater time stamp than the GPS file—say, 6 minutes. In another example scenario, the video frame being synchronized is a lesser time stamp than the GPS file—say, 4 minutes. In the 6 minute example, the start of the GPS file is the first GPS data record, and the video is begun at the frame 5 minutes before the synchronization frame or the frame at a time stamp of 1 minute. In this scenario, the first one minute of video does not correspond to any GPS data and it is cropped or otherwise deleted. Alternatively, a start indicator is included in the video file at the location and the preceding video is not cropped. Alternatively, the start time is saved or otherwise recorded in a separate synchronize record or meta-data included with one or both files or as a separate file. In yet another example, it is also possible to store a time offset in either or both files, or in the meta file. In the 4 minute example, the start of the video file is the first frame of video and the start of the synchronized GPS file is at the GPS coordinates 4 minutes less than the synchronization GPS record (the GPS record at a time stamp of 1 minute). Here, the first minute of the GPS data does not correspond to any video so the first minute is cropped or otherwise deleted. Alternatively, a start indicator is included in the GPS file and the GPS data preceding the start is not deleted. Alternatively, the start time is saved or otherwise recorded in a separate synchronization record or meta-data included with one or both files. In either case, the two files are synchronized by having time information or some other common temporal information for the discrete data elements (GPS coordinates or video frame) of the respective video files and GPS files. In the first example, the video file is cropped or marked to synchronize to the start of the GPS file whereas in the second example the GPS file is cropped or marked to synchronize to the start of the video file.

In the instance where a location on the map is selected to match the first frame of the video file, the GPS file is cropped to remove the GPS data elements preceding the start indicator. Alternatively, the GPS file is not actually cropped but is instead marked, a separate file or meta data is created that identifies the starting GPS data element, or a time offset is defined. For example, if 10 minutes of GPS data precede the GPS data point associated with the start indicator, then that 10 minutes of data is removed from the GPS file and not included with the synchronization files. In such a case, the files are synchronized at the beginning of the respective files. Alternatively, the actual starting GPS data element is marked or otherwise identified. Similarly, the GPS file is either marked or cropped to identify or remove any GPS data elements that exceed the length of the video. So, for example, if the video has a total length of 10 minutes, and the GPS file has 15 minutes of GPS records after the GPS data point at the start indicator, then the GPS data records from 10 to 15 minutes are cropped, deleted or otherwise removed from the GPS file, or the ending data element is marked or otherwise identified and the data elements after the last element are not made available or displayed for the third parties.

When the synchronization operation is complete, depending on whether synchronization is involved, there is an index generated that maps the geographic data file to the video file to synchronize the two. In one specific example, after the video or GPS file is physically or virtually cropped (when the files differ in length), the starting GPS data element is indexed to the first frame of the video file. The data files with any associating indexing information are then stored at a remote data location, such as the database 114, by the web uploader, and are thereby available for access over the network or for other purposes.

More specifically, when the synchronization operations are complete and the user decides to upload the actual files to the database, a communication between the server 108, using an API, initiates the collection of the appropriate files. In one specific example, the server initiates the transfer of the video file, which may be transferred in discrete chunks, the associated and synchronized GPS file and a meta-data file. The meta-data file may include a name, a length, a vehicle description (bicycle, car, etc.) and a file description, among other attributes. In some instances the meta-data file may include linking data. Referring again to FIG. 3A, the user may enter some of this information through the video information area 308 that includes a title window where the user enters a title, a description window where the user enters a description of the video, and also includes other fields that may be automatically generated through analyzing the video or geographic data file or user entered. The server then copies the files to the database.

In one specific example, meta-data may be provided in a .kino file (or other file extension) that is XML formatted. The XML fields may include the title of the track (as entered by the user), the description of the type of track (a text description entered by the user that summarizes the course), the type of vehicle or other mechanism from which the video was taken (car, 4×4, cycle, etc.), and the video format of the video (e.g., mp3, mp4, avi, wmv, 3gp, etc.). The XML fields may further include:
startAddress: full address of the first GPS point, which may be manually entered, may be determined using Google reverse geocoding API or the like, and may be transmitted with the meta-data or may be obtained and populated by the server
endAddress: full address of the last GPS point, which may be manually entered, may be determined using Google reverse geocoding API or the like, and may be transmitted with the meta-data or may be obtained and populated by the server
length: the length of the total track (route) in meters. If missing from the meta-file, the server calculates it from the gps file and stores it in the GPS file.
defaultMapType: street or satellite. If missing, default value is “no_pref”
hardwareModel: information about the hardware model. For example: Windows 7. If missing, default value is empty
privacy: the visibility of the track: public, unlisted, or private (each of which may be defined by user with the web-uploader) or sandbox (in this case, the track is private but deleted after two days automatically). If missing, default value is public
thumbnail: the position in seconds of the thumbnail you want (0<thumbnail<duration of the video). The thumbnail image is displayed on a website or other location and may be an identifier.
videoRotate: the angle in degree to rotate the video (−270, −180, 90, 0, 90, 180, 270). This field is used to reorient the video in the event it was recorded at some orientation other than 0 degrees.
videoMute: true to mute the video when transcoding (if the recording app transcodes it, the user enters this parameter so that only the video is available to other users and not the audio track). If missing, false
offset: difference in seconds between the first valid GPS point and the beginning of the video (example: an offset of 7.235 means that the first valid GPS point was received 7.235 seconds after the beginning of the video, an offset of −7.235 means that the first valid GPS point was received 7.235 seconds before the beginning of the video). Note, the offset may also address the first valid video frame relative to the GPS data.
timezone: the current timezone where the video was recorded (for example 3600 second: GMT+01:00, −5400 second: GMT−01:30))

An email is sent to the contributor when this process is complete and the synchronized data sets are ready for sharing and using in apps or the like. While a database is shown and discussed, the term database in the context of this application can include various possible cloud-based storage systems and may be provided in a discrete location, such as a data center, or may be stored or otherwise distributed across one or more physical or virtual locations. Similarly, while a single server is shown in FIG. 1, it is possible for the system to use several servers, and those servers may be geographically distributed. Copies of the data files, which may depend on popularity or other attributes, may be replicated or otherwise distributed to different locations to assist in the distribution of the files to third parties, such as through a content delivery network.

The stored data may be organized with a first set of data that contains one line in the database for each video and a second set of data that contains one line in the database for geographic data set. The stored data may also be organized to include a third set of data concerning the creator of the video and/or geographic data files, and other meta-data. The data fields for each data set type (video, geographic coordinate and member) may be illustrated or otherwise discussed with reference to three associated database tables. Each table references various possible data fields for each data set, and may also reference meta information (meta data) as well as synchronization information that creates a relationship between the data sets.

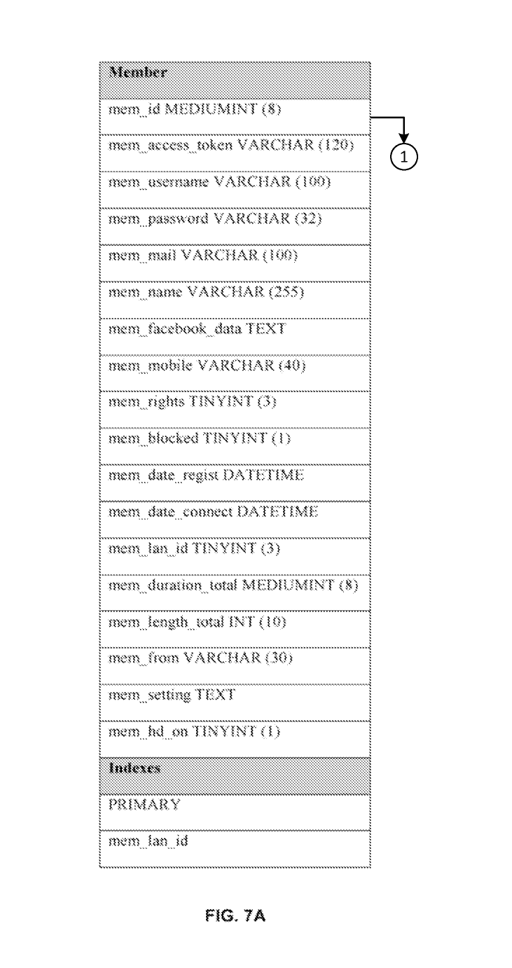

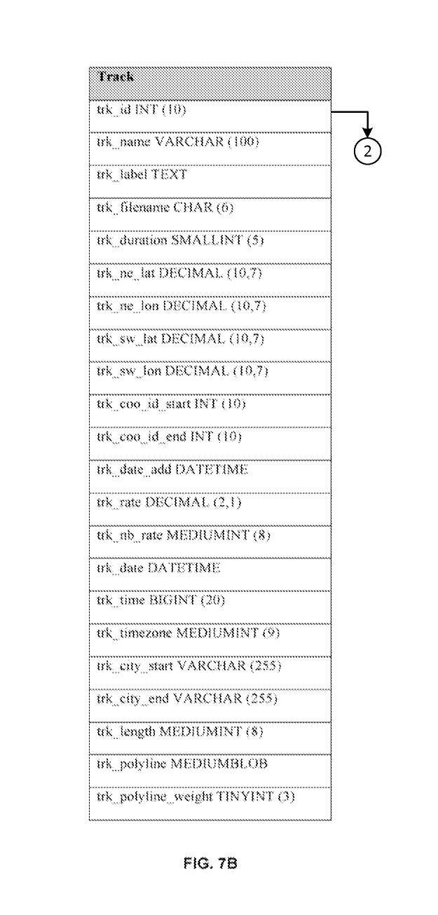

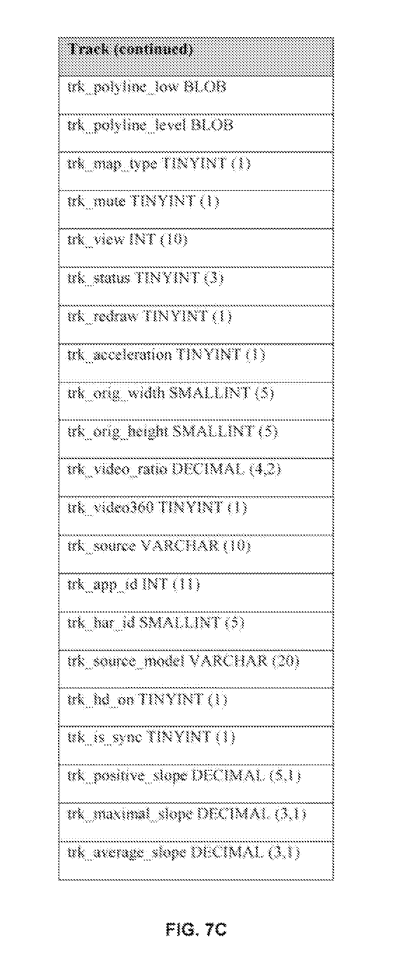

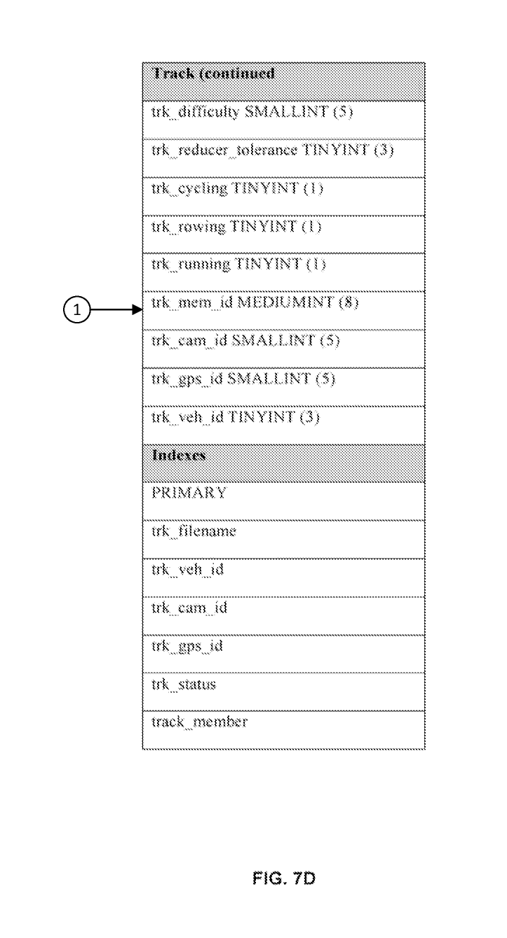

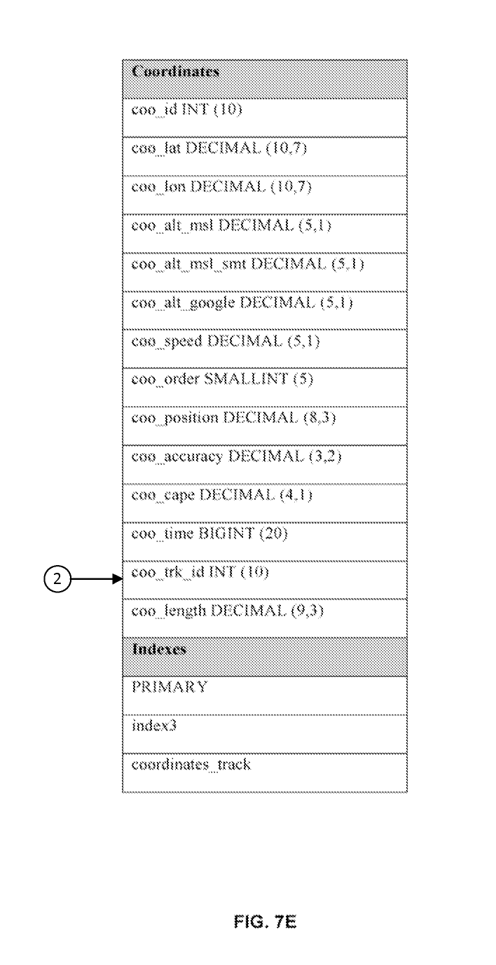

More specifically, FIG. 7 shows a member table, a track table (video) and a coordinates table (geographic), along with data types and definitions for each associated set of data. In this example, the member table includes various possible data fields related to the creator and/or creation of the video and/or geographic data. The track table includes various data fields related to the video data among other data fields. The coordinate table includes various data fields related to the geographic data among other data fields. The data tables also illustrate keys including a primary key that uniquely relates to a particular set of data and a foreign key that creates a data path or otherwise links two or more sets of data. So, for example, the track table may include a primary key that is uniquely assigned to one particular set of track data, and it may also include a foreign key that identifies the member (and associated member table) that created the track data.

More specifically, referring first to the member table, a primary key in the form of a member identification (mem_id) is shown as the first entry in the member table. The same data is included in the track table (trk_mem_id), which provides a data linking element between the two tables (and data) by establishing a relationship between the two sets of data. Specifically, the trk_mem_id may be a foreign key, based on the mem_id, that established a data link between the member table and the track table.

The member table includes several data fields related specifically to the creator or uploader of the video and geographic data. In this specific case, a member has an account or is otherwise a registered user of the system, although the system does not require member accounts in order to function for the purpose of uploading synchronized video and geographic data. Specifically, the member table may include a username entry, a password entry, a mail (email) entry, a name entry, a Facebook (or other social media(s)) entry (Facebook user information for the member), and other information related to the member. The member table may also include information and synchronization information associated with the video and geographic data created or otherwise uploaded by the member. For example, the member table may include a duration_total data element associated with the length of the video and a length_total data element associated with the length of the GPS coordinate file, where the three sets of data are linked through keys and are associated with a particular video, a particular set of geographic data, and created by a specific member. Of course, a member may up-load any number of synchronized data sets, in which case common member data elements for the member table will be used and unique data elements associated with a specific video and set of coordinate data will also be included in the database entries.

The track table includes numerous data fields associated with a video file. In one example, each video file and each line in the track table represents one specific uploaded and synchronized video in the database. More specifically, the id is a unique identifier of the video. Note, the track table data entries includes the prefix “trk” which is left off this discussion for convenience. The name field is the name chosen or entered by the member. For example, referring to FIG. 3A, the name field is populated with the name the user enters in the title field. The label is a description of the video as entered by the member, such as through the description field of FIG. 3A. The filename is an alphanumeric identifier of the video file, which may be an identifier of the video that made visible on various screens accessible by various users of the system. The duration field includes information as to the number of seconds of video to which there is corresponding geographic data. So, for example, if the video is 10 minutes but there is only GPS data for minutes 2-10, then the duration field would be 480 seconds (8 minutes of video that has corresponding GPS data).

The ne_lat, ne_long, sw_lat, and sw_long data fields define the latitude and longitude coordinates for a bounding rectangle to define the initial map for the video. The coo_id_start and the coo_id_end are identifiers to the first and last GPS coordinates associated with the video. These values may be particular instances of synchronization information. These values may be updated and/or defined when the user sets the start and/or end locations on the map. The first and last GPS coordinates may be found in the coordinates table.

Still referring to the coordinates table, the table also includes creation data information, data of uploading information, rating information (e.g., 1-5 stars), average rating information, identification information associated with those rating the video, the date and time of the start of the video recording, time zone information for the location where the video was recorded, a length (e.g., meters) of the video, which may be derived from the geographic data, and the geographic addresses for the start and the end locations of the video. The addresses may be derived from a reverse geolocating service based on the GPS coordinates for the start and end of the video or manually entered by the member.

The table may further include a polyline field providing a mechanism (equation) by which a course, associated with the GPS coordinates for the video file, may be rendered on a digital map. The polyline information may further be supplemented with polyline weighting information and resolution information. The table may include numerous other types of data associated with the video including:
trk_length: length in meters of the video
trk_map_type: default view for a video: map or satellite
trk_mute: boolean, if the user has decided to remove the sound of the video
trk_view: current number of views of a video
trk_status: ID to sort videos between Public, Unlisted, Removed, etc
trk_acceleration: if the video has acceleration data associated to it
trk_orig_xxx: resolution of the original video
trk_video_ratio: ratio of the video resolution (often 1.33=4/3 or 16/9)
trk_video360: 360 videos
trk_source: strings containing information about the device used to record/upload (e.g.: “iPhone 5”)
trk_app_id: application ID used to upload the video (used in upload API)
trk_cycling, running, and rowing: identifying the activity associated with the video
trk_veh_id: ID of the vehicle used by the contributor

Other fields are shown in the table the meaning of which may be understood from the data names. Further, it will be apparent that some data elements of each table are defined or obtained from the originally uploaded data. Other fields are define or modified afterward. For example, the trk_view is tracked by an application running on the server that increments the data value each time a user downloads or views the video.

The coordinates table includes a number of data entries including:
coo_id: ID of the coordinate (primary key)
coo_lat, coo_lon: latitude and longitude
coo_alt_msl: altitude (the other one is a variant based on the level of the sea)
coo_alt_google: altitude recalculated by a geocoding service, to improve the precision of the altitude data collected or otherwise calculated by some GPS systems
coo_speed: instant speed
coo_order: An index of the coordinate in the array of coordinate for a specific track.
coo_accuracy: accuracy of GPS signal
coo_cape: instant bearing, cape
coo_time: similar to coo_order but with the timestamp of the video (can be different from coo_order if not 1 hertz video). For example, the value is a unix timestamp for each coordinate, and may be used to temporally align the coordinate data with the track data.
coo_trk_id: ID of the video
coo_length: cumulated length of the video since the beginning to this particular set of geographic data coordinates.

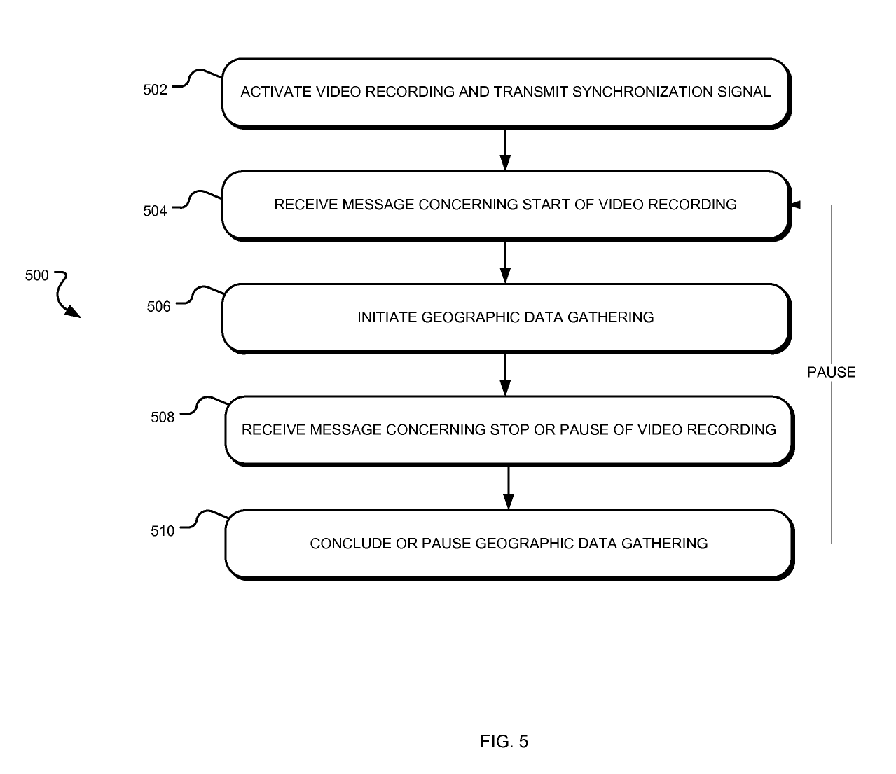

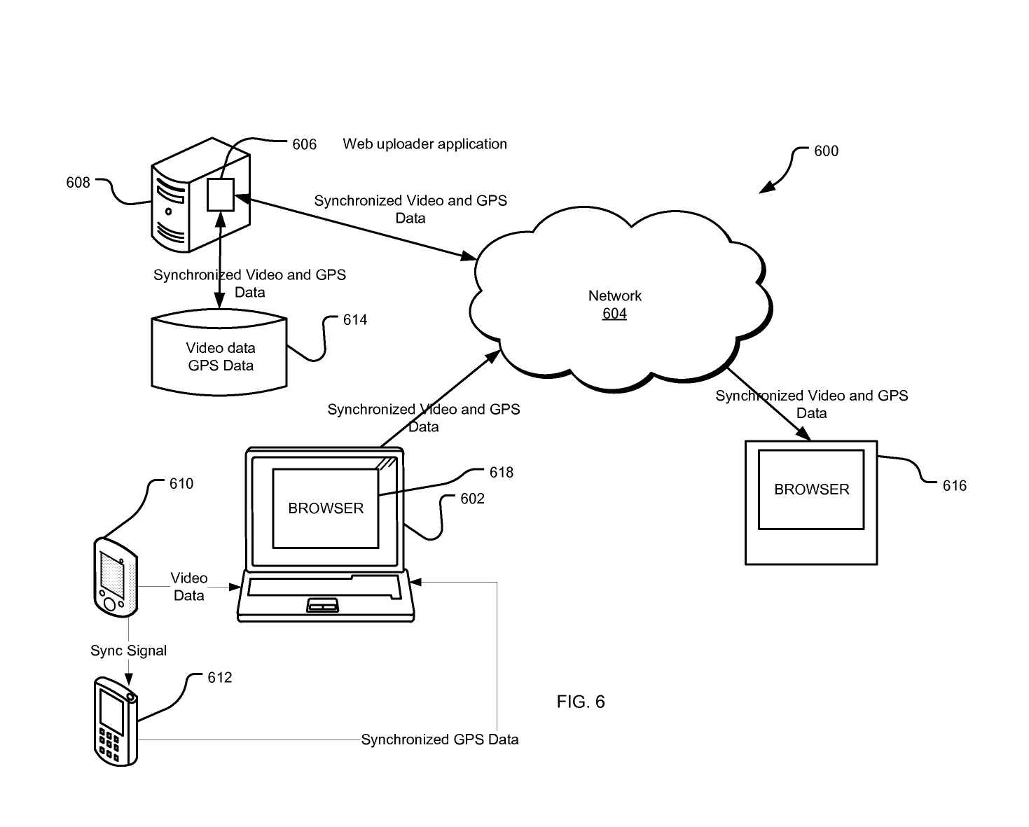

FIGS. 5 and 6 illustrate one example of a system and an associated method for automatically generating a geographic data file synchronized with a video file. Referring first to FIG. 6, it can be seen that the system resembles the system disclosed in FIG. 1. Namely, a user device 602 is in communication with a web-uploader application 606 by way of a network 604. In this example, video data is recorded by a digital recording device 610 and geographic data is recorded by a GPS receiver device 612. It is possible that the video device or the GPS device may also serve the function of the user device 602 even though these functions are illustrated as being performed by separate devices. Synchronized video data and geographic data are stored in a database 614 that is accessible by a third party using a device 616 with a browser and network connection or may also be accessed and used by a third party device.

Turning more specifically to the GPS device, in this example, the GPS device is a smart phone or similar device with a GPS chip set and associated GPS functionality. Accordingly, the device is able to generate and store a GPS data file. The GPS device in this example includes an application, which may be an “app,” that when running is configured to receive or otherwise detect a synchronization signal from the video recording device. Referring to FIG. 5, in one example, the video recording device transmits the synchronization signal when the recording is initiated (operation 502). Besides transmitting a synchronization signal, a name of the video file along with a timestamp for the start of the video file will also be transmitted. Alternatively, some other form of unique video file indicator may be transmitted. Further, other information concerning the start of the video file may be transmitted. Upon receipt of the signal, the GPS device begins a GPS data file (operations 504 and 506). In one instance, the GPS device records a geographic data file using the same name or indicator as the video file, although the geographic data file will include a different file extension. In such an example, the name of the data file provides an indicator of a unique relationship between the files when the files are stored in the database. Alternatively, the unique time indicator may provide the link between the two files as the same device will not be recording different videos at the same time. Similarly, when video recording is stopped or paused, the video device signal transmits an appropriate synchronization signal that is received by the GPS device (operation 508). The device may handle a pause the same as a stop by creating a new video file and a corresponding new GPS file rather than starting and stopping the same file. In the case of a pause, the GPS device pauses the recording the GPS data file and then resumes recording GPS data when a subsequent record synchronization signal is received. In the case of receiving a stop synchronization command, the GPS receiver stops recording and notes the end of the GPS file (operation 510). The files may then be transferred to the database using the web-uploader as discussed herein. Examples of transferring the files are discussed herein in the context of performing some form of synchronization and otherwise using a web-uploader application. It is possible, however, to transfer the files using other mechanisms such as through FTP, particularly in the case where the files are natively synchronized by recording both files with the same device or having one device automatically synchronize the recording of the second file.

Referring again now to FIGS. 2 and 4, after a user has uploaded video and geographic data to the server, and the server has received and stored the synchronized data (operation 21), a user, which may be the same as the member that uploaded the data or a third party, or an application, may access and download the synchronized data (operation 212). When a user at a browser operating on a device 116 (see FIG. 1, see also device 616, FIG. 6) requests a video and geographic data, the server 108 (608) may return the information in a data stream formatted in XML. For example, the coordinate data may be provided as follows:

<trackData>

<coordinates>

<coordinate>
<coo_lat>46.5141547</coo_lat> (latitude)
<coo_lon>6.6185507</coo_lon> (longitude)
<coo_alt_msl>403.5</coo_alt_msl> (altitude)
<coo_alt_google>410.3</coo_alt_google> (altitude)
<coo_speed>0.2</coo_speed> (speed)
<coo_position>1.000</coo_position>
<coo_time>1335273181500</coo_time> (time stamp of
coordinate)
<coo_length>0.000</coo_length> (accumulated length in
meters)

</coordinate>

A sequence of XML data for a given coordinate file may be transmitted to the user device. So, for example, if there are 100 GPS coordinates in the file, then 100 sets of XML coordinate data may be transmitted. The coordinate data in the XML stream includes latitude and longitude information, altitude or elevation information, speed information (the speed of travel when the latitude and longitude information was received), position information, time information (the relative time since the first geographic element), and the accumulated length.

The XML data for the track data may be provided as follows:

<tracks>

<track>

<id>amxzmi</id> (video key)
<title>Prologue tour de Romandie Lausanne 2012</title> (title of video)
<duration>231</duration> (duration of video in seconds)
<view>2776</view> (number of video views)
<rate>5.0</rate> (rating)
<length>3379</length>
<reducerTolerance>4</reducerTolerance>
<averageSpeed>14.63</averageSpeed>
<member>jeremyroy</member> (member identifier)
<cycling>1</cycling> (1 if video filmed while cycling)
<rowing>0</rowing> (1 if video filmed while rowing)
<running>0</running> (1 if video filmed while running)
<country>Switzerland</country> (country where video filmed)
<thumbnailSmallUrl>http://dgc8ikbqj4rw4.cloudfront.net/a/m/amxzmi_80x60.j
pg</thumbnailSmallUrl> (link to thumbnail image)
<thumbnailMediumUrl>http://dgc8ikbqj4rw4.cloudfront.net/a/m/amxzmi_320x
240.jpg</thumbnailMediumUrl> (link to larger thumbnail image
<positive_slope>60.5</positive_slope>
<difficulty>1</difficulty>
<hd>1</hd> (1 if video is high definition format)
<heartRate>0</heartRate> (1 if heart rate data)
<status>public</status> (access type - public or private)
<video> (link to streaming source)
<video HD> (link to streaming source for HD video)

</track>

The coordinate data and track data that is sent to the user or device is temporally aligned so additional synchronization information is not necessary but may nonetheless be sent.

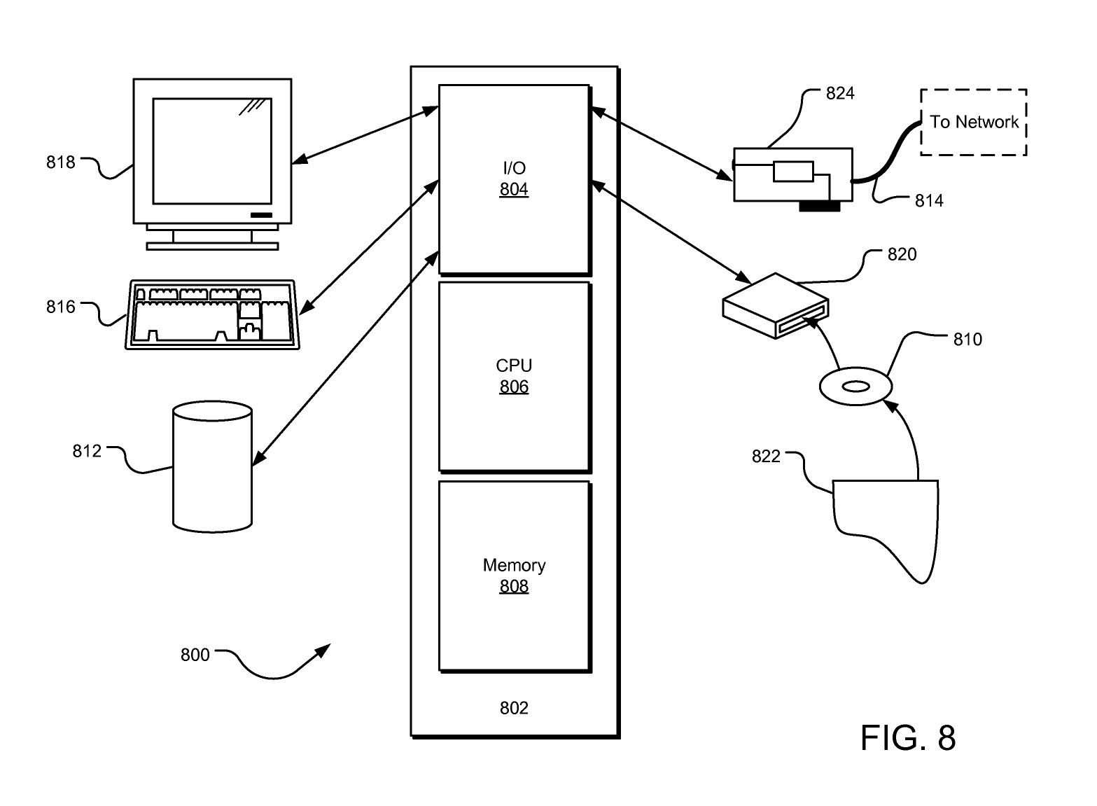

Referring to FIG. 8, a detailed description of an example computing system 800 that may implement various systems and methods discussed herein is provided. The computing system may be applicable to the user device 102, the server 108, the geographic position device 12 (in which case GPS chips may be included), the video device 110 (in which optics and video chips may be included), the third party device 116, as well as other devices discussed herein. It should be noted that specific implementations of these devices may be of differing possible specific computing architectures not all of which are specifically discussed herein. A general purpose computer system 800 is capable of executing a computer program product to execute a computer process, such as the methods discussed herein. Data and program files may be input to the computer system 800, which reads the files and executes the programs therein. Some of the elements of a general purpose computer system 800 are shown in FIG. 8 wherein a processor 802 is shown having an input/output (I/O) section 804, a Central Processing Unit (CPU) 806, and a memory section 808. There may be one or more processors 802, such that the processor 802 of the computer system 800 comprises a single central-processing unit 806, or a plurality of processing units, commonly referred to as a parallel processing environment or a multi-core processing environment. The computer system 800 may be a conventional computer, a distributed computer, or any other type of computer, such as one or more external computers made available via a cloud computing architecture. Some aspects of the presently described technology may be optionally implemented in software devices loaded in memory 808, stored on a configured DVD/CD-ROM 810 or storage unit 812, and/or communicated via a wired or wireless network link 814, thereby transforming the computer system 800 in FIG. 8 to a special purpose machine for implementing the described operations.

The I/O section 804 is connected to one or more user-interface devices (e.g., a keyboard 616 and a display unit 818), a disc storage unit 812, and a disc drive unit 820. In the case of a tablet or smart phone device, there may not be physical keyboard but rather a touch screen with a computer generated touch screen keyboard. Generally, the disc drive unit 820 is a DVD/CD-ROM drive unit capable of reading the DVD/CD-ROM medium 810, which typically contains programs and data 822. Computer program products containing mechanisms to effectuate the systems and methods in accordance with the presently described technology may reside in the memory section 804, on a disc storage unit 812, on the DVD/CD-ROM medium 810 of the computer system 800, or on external storage devices made available via a cloud computing architecture with such computer program products, including one or more database management products, web server products, application server products, and/or other additional software components. Alternatively, a disc drive unit 820 may be replaced or supplemented by other storage medium drive unit types. Similarly, the disc drive unit may be replaced or supplemented with a random access memory (RAM) and/or various possible forms of semiconductor based memories commonly found in smart phones and tablets. The network adapter 824 is capable of connecting the computer system 800 to a network via the network link 814, through which the computer system can receive instructions and data. Examples of such systems include personal computers, Intel or PowerPC-based computing systems, AMD-based computing systems and other systems running a Windows-based, a UNIX-based, I/Os or other operating systems. It should be understood that computing systems may also embody devices such as personal digital assistants (PDAs), mobile phones, smart phones, tablets or slates, multimedia consoles, gaming consoles, set top boxes, etc.

When used in a LAN-networking environment, the computer system 800 is connected (by wired connection or wirelessly) to a local network through the network interface or adapter 824, which is one type of communications device. When used in a WAN-networking environment, the computer system 800 typically includes a modem, a network adapter, or any other type of communications device for establishing communications over the wide area network. In a networked environment, program modules depicted relative to the computer system 600 or portions thereof, may be stored in a remote memory storage device. It is appreciated that the network connections shown are examples of communications devices for and other means of establishing a communications link between the computers may be used.

Some or all of the operations described herein may be performed by the processor 802. Further, local computing systems, remote data sources and/or services, and other associated logic represent firmware, hardware, and/or software configured to control operations of the web-uploader 106, the user devices 102, 116, or the other devices 112 and 110. Such services may be implemented using a general purpose computer and specialized software (such as a server executing service software), a special purpose computing system and specialized software (such as a mobile device or network appliance executing service software), or other computing configurations. In addition, one or more functionalities disclosed herein may be generated by the processor 802 and a user may interact with a Graphical User Interface (GUI) using one or more user-interface devices (e.g., the keyboard 816, the display unit 818, and the user devices 804) with some of the data in use directly coming from online sources and data stores. The system set forth in FIG. 8 is but one possible example of a computer system that may employ or be configured in accordance with aspects of the present disclosure.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium (e.g., floppy diskette), optical storage medium (e.g., CD-ROM); magneto-optical storage medium, read only memory (ROM); random access memory (RAM); erasable programmable memory (e.g., EPROM and EEPROM); flash memory; or other types of medium suitable for storing electronic instructions.

The description above includes example systems, methods, techniques, instruction sequences, and/or computer program products that embody techniques of the present disclosure. However, it is understood that the described disclosure may be practiced without these specific details.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method of data synchronization comprising:
within a browser operating on a computing device, receiving a video data file and a geographic data file;
displaying an image from the video data file;
displaying a route corresponding to the geographic data file; and
receiving a selection on the route identifying a location corresponding to the image from the video data file, the selection generating a synchronization association between the geographic data file and the video data file.

2. The method of claim 1 wherein the synchronization association includes a temporal synchronization between the video data file and the geographic data file by associating a first time value of a frame associated with the image from the video data file and a second time value associated with the selection on the route identifying the location corresponding to the image.

3. The method of claim 2 wherein the association of the first time value of the frame and the second time value associated with the selection on the route includes generating a time offset between a start of the video data file and a start of the geographic data file, the time offset based on determining an elapsed time between the start of the geographic data file and the second time value associated with the selection on the route identifying the location corresponding to the image.

4. The method of claim 3 wherein the time offset is a positive value when the start of the geographic data file temporally follows the start of the video data file by the time offset, the time offset is a negative value when the start of the geographic data file temporally precedes the start of the video data file by the time offset, and is a zero value when the start of the geographic data file substantially temporally matches the start of the video data file.

5. The method of claim 3 further comprising cropping the video data file to remove any frames temporally preceding the start of the geographic data file based on the time offset.

6. The method of claim 3 further comprising defining a start indicator associated with the video data file, the start indicator associated with at least one frame at the time offset from the start of the video data file.

7. The method of claim 4 further comprising generating a meta-data file including the time offset.

8. The method of claim 1 further comprising displaying a digital map of an area encompassing the route.

9. The method of claim 1 further comprising:
receiving a file including video data and geographic data; and
separating the video data from the geographic data to create the video data file and the geographic data file.

10. A system of data synchronization comprising:
at a server, providing access to an application in response to a request, the application configured to run within a browser at a computing device from which the request was initiated, the application further configured to receive a video data file and a geographic data file and to cause a display of an image from the video data file and a display of a route corresponding to the geographic data file, the application further configured to process a selection on the route identifying a location corresponding to the image from the video data file, the selection establishing a synchronization link between the geographic data file and the video data file.

11. The system of claim 10 wherein the server is further configured to receive the geographic data file and the video data file and to store the video data file and the geographic data file in a database with at least one key establishing a relationship between the video data file and the geographic data file.

12. The system of claim 10 wherein the application is further configured to produce meta data with information concerning attributes of a user that created the video data and the geographic data.

13. The system of claim 10 wherein the synchronization link includes a temporal association between the video data file and the geographic data file by associating a first time value of a frame associated with the image from the video data file and a second time value associated with the selection on the route identifying the location corresponding to the image.

14. The system of claim 13 wherein the association of the first time value of the frame and the second time value associated with the selection on the route includes obtaining a time offset between a start of the video data file and a start of the geographic data file, the time offset based on determining an elapsed time between the start of the geographic data file and the second time value associated with the selection on the route identifying the location corresponding to the image.

15. The system of claim 14 wherein the time offset is a positive value when the start of the geographic data file temporally follows the start of the video data file by the time offset, the time offset is a negative value when the start of the geographic data file temporally precedes the start of the video data file by the time offset, and is a zero value when the start of the geographic data file substantially temporally matches the start of the video data file.

16. The system of claim 15 wherein the video data file is cropped to remove any frames temporally preceding the start of the geographic data file based on the time offset.

17. The system of claim 15 wherein a start indicator is associated with the video data file, the start indicator associated with at least one frame at the time offset from the start of the video data file.

18. The system of claim 14 further comprising, at the server, obtaining a meta-data file including the time offset.

19. The system of claim 10 further comprising, at the server, receiving a request for the video data file and geographic data file; and, providing the video data file and the geographic data file along with the synchronization information.

20. The system of claim 19 wherein the video data file and the geographic data file are formatted in XML, and the synchronization information is providing in a meta-data file formatted in XML.

21. A system of data synchronization comprising:
at a server, providing access to an application in response to a request, the application configured to run within a browser at a computing device from which the request was initiated, the application further configured to receive a video data file and to extract geographic data embedded within the video data file and to create a geographic data file from the extracted geographic data.

22. The system of claim 21 further comprising identifying a sub-title field within the video data file that identifies the embedded geographic data.

23. The system of claim 21 wherein the application is further configured to cause the display of an image from the video data file and a route corresponding to the geographic data file.

24. The system of claim 21 wherein the application is further configured to process a selection on the route identifying a location corresponding to the image from the video data file, the selection establishing a synchronization link between the geographic data file and the video data file.

25. The system of claim 24:
wherein the synchronization link includes a temporal association between the video data file and the geographic data file by associating a first time value of a frame associated with the image from the video data file and a second time value associated with the selection on the route identifying the location corresponding to the image; and
wherein the association of the first time value of the frame and the second time value associated with the selection on the route includes a time offset between a start of the video data file and a start of the geographic data file, the time offset based on an elapsed time between the start of the geographic data file and the second time value associated with the selection on the route identifying the location corresponding to the image.

26. The system of claim 24 further comprising, at the server, receiving a request for the video data file and geographic data file; and providing the video data file and the geographic data file along with the synchronization link.

27. A method of synchronizing video and geographic data comprising:
receiving a first wireless message indicating an initiation of recording a first data file at a first recording device; and
at a second device, initiating a recording of a second data file at the second device in response to the receipt of the first wireless message.

28. The method of claim 27 wherein the first device is a video recording device and the second device is a geographic data recording device, and wherein the first data file is a video taken along a route and the second data file is a geographic position system data file of the route.

29. The method of claim 28 wherein the wireless message includes at least one identifying attribute of the first data file, the at least one identifying attribute associated with the second data file.

30. The method of claim 29 further comprising automatically stopping recording of the second data file at the second device in response to the receipt of a second wireless message generated when recording of the first data file is stopped.

31. The method of claim 27 wherein the first data file and the second data file are temporally synchronized between a start and an end of each data file based on the first wireless message and the second wireless message.
